(19) United States
(12) Patent Application Publication
(10) Pub. No.: US 2024/0145749 A1
(43) Pub. Date: May 2, 2024

(54) CONTROLLED RELEASE OF ANTIOXIDANT FOR FUEL CELLS

(71) Applicant: Toyota Motor Engineering & Manufacturing North America, Inc., Plano, TX (US)

(72) Inventors: Liang Wang, Saline, MI (US); Hongfei Jia, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/486,595

(22) Filed: Oct. 13, 2023

Related U.S. Application Data
(60) Provisional application No. 63/379,615, filed on Oct. 14, 2022.

(51) Int. Cl. H01M 8/1004; H01M 8/0239; H01M 8/1046

(52) U.S. Cl. CPC H01M 8/1004; H01M 8/0239; H01M 8/1046; H01M 2220/20

(57) ABSTRACT

Microcapsule and microsphere controlled release forms of antioxidants such as cerium oxide to improve durability, and extend the lifetime of fuel cells are disclosed. Membrane electrode assemblies (MEAs) and polymer electrolyte membrane fuel cells (PEMFCs) employing the controlled release forms and methods of mitigating or suppressing cerium migration in fuel cells are also disclosed.

### TECHNICAL FIELD

The present disclosure generally relates to fuel cells, and more particularly, to the use of controlled release antioxidants to improve durability, and to extend the lifetime of fuel cells.

### BACKGROUND

The background description provided herein is for the purpose of generally presenting the context of the disclosure.

Fuel cell vehicles represent a promising option for future mobility because they afford high energy efficiency and include a zero-emission powertrain platform. Current commercially available fuel cell vehicles use polymer electrolyte membrane fuel cells (PEMFCs). While the PEMFC technology has been commercialized for decades, it still faces major challenges of high material costs and a substantial performance gap.

One issue with the use of PEMFCs is the need for a longer operational lifetime of the fuel cell in a vehicle. Current fuel cells typically can provide an operational lifetime of 5,000 hours. A significantly longer lifetime, however, would be beneficial to passenger vehicles and is needed for the practical use of fuel cells in commercial vehicles and heavy-duty trucks. Passenger vehicles would benefit from at least 8,000 hours of operational lifetime, and heavy-duty trucks, for example, require at least 25,000 hours of operational lifetime, and more preferably 30,000 hours according to US Department of Energy's 2050 target. Therefore, it would be desirable to develop improved PEMFCs that have a longer lifecycle.

### SUMMARY

This section provides a general summary of the disclosure and is not a comprehensive disclosure of its full scope or all of its features.

In various aspects, the present disclosure provides a membrane-electrode assembly comprising: an anode comprising a first catalyst; a cathode comprising a second catalyst; and a proton exchange membrane between the anode and cathode. The at least one of the proton exchange membrane, anode, and cathode comprise an antioxidant which comprises cerium oxide microparticles in a controlled release form selected from microcapsules or microspheres configured to release cerium oxide over time. Yttrium doped cerium oxide, zirconium doped cerium oxide, and manganese oxide may also be employed as an antioxidant within the scope of the present disclosure.

In other aspects, the present disclosure provides a fuel cell comprising: a membrane-electrode assembly comprising a proton exchange membrane, an anode comprising a first catalyst, and a cathode comprising a second catalyst. The proton exchange membrane is positioned between the anode and cathode. A first microporous layer contacts the anode and a second microporous layer contacts the cathode. An anode diffusion layer contacts the first microporous layer and a cathode diffusion layer contacts the second microporous layer. A first flow channel contacting the anode diffusion layer; and a second flow channel connecting the cathode diffusion layer. At least one of the proton exchange membrane, anode, cathode, first microporous layer and the second microporous layer comprise a cerium oxide antioxidant in a controlled release form selected from microcapsules or microspheres configured to release of cerium oxide over time. Yttrium doped cerium oxide, zirconium doped cerium oxide, and manganese oxide may also be employed as an antioxidant within the scope of the present disclosure.

In other aspects the present disclosure provides a method for suppressing cerium ion migration in a proton exchange membrane fuel cell (PEMFC) wherein the PEMFC comprises a membrane-electrode assembly (MEA). The MEA comprises a proton exchange membrane, an anode comprising a first catalyst, and a cathode comprising a second catalyst. The proton exchange membrane comprises a perfluorosulfonic acid polymer and positioned between the anode and cathode; a first microporous layer contacting the anode; a second microporous layer contacting the cathode; an anode diffusion layer contacting the first microporous layer; a cathode diffusion layer contacting the second microporous layer; a first flow channel contacting the anode diffusion layer; and a second flow channel connecting the cathode diffusion layer. The method comprises loading a predetermined amount of cerium oxide antioxidant to the membrane-electrode assembly, in a controlled release form selected from microcapsules or microspheres configured to release cerium oxide over time. Yttrium doped cerium oxide, zirconium doped cerium oxide, and manganese oxide may also be employed as an antioxidant within the scope of the present disclosure.

In yet other aspects, the present disclosure provides vehicles comprising fuel cells described herein.

Further areas of applicability and various methods of enhancing the above technology will become apparent from the description provided herein. The description and specific examples in this summary are intended for purposes of illustration only and are not intended to limit the scope of the present disclosure.

### DRAWINGS

The present teachings will become more fully understood from the detailed description and the accompanying drawings wherein:

FIG. 1 is a cross-sectional view of an exemplary membrane-electrode (MEA) assembly of the present disclosure.

FIG. 2 is a cross-sectional view of a portion of an exemplary fuel cell of the present disclosure.

FIG. 3 is a cross-sectional view of a portion of an exemplary fuel cell of the present disclosure.

FIG. 4 is a schematic cross-sectional view of a portion of an exemplary fuel cell of the present disclosure.

FIG. 5 is an illustration of an antioxidant microcapsule controlled release form of the present disclosure.

FIG. 6 is a schematic illustration of the antioxidant controlled release profile with microcapsules of the present disclosure using Ce02/Ce ions as an example.

FIG. 7 is an illustration of an antioxidant microsphere controlled release form of the present disclosure.

FIG. 8 is a schematic illustration of the antioxidant controlled release profile with microspheres of the present disclosure using Ce02/Ce ions as an example.

FIGS. 9A, 9B, and 9C are Scanning Electron Microscope (SEM) images showing urea-formaldehyde CeO₂ (UF/CeO₂) microcapsules of the disclosure. FIGS. 9B and 9C are cross-section views of the microcapsules.

FIG. 10 is an illustration of the degradation of the polymer shell of the microcapsule and release of the radical quencher, i.e., CeO2.

FIGS. 11A, 11B, and 11C are NMR spectra results from the benzenesulfonic acid degradation test.

FIG. 12 is a graph showing the benzenesulfonic acid and H₂O₂ concentrations that remain after degradation.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DESCRIPTION

The present disclosure provides an improvement in the chemical stability of the proton exchange membrane fuel cell (PEMFC) components by providing an antioxidant to quench radicals that damage the proton exchange membrane and negatively impact the life of the fuel cell. The antioxidants described herein are designed to control the timing of the release of the radical quencher for an extended lifetime, thereby improving the fuel cell lifespan. In particular, the antioxidants of the present disclosure are designed such that the radical quencher is protected by a polymer shell or by formation of a composite with a polymer, such as a microsphere to enable controlled release of the radical quencher.

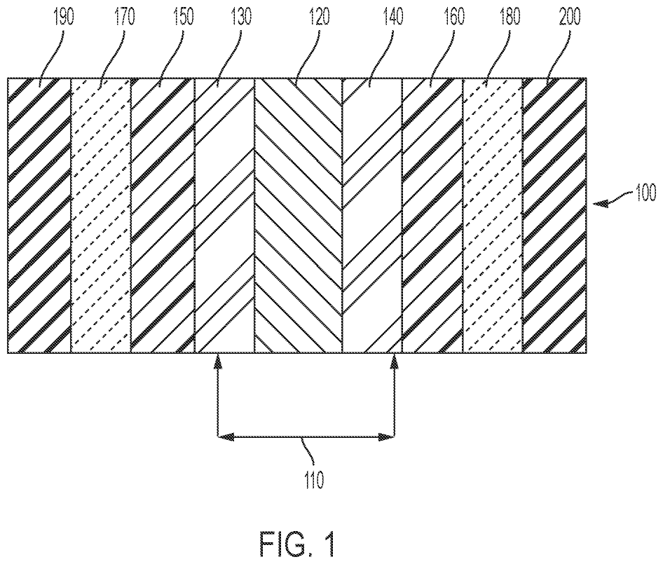

PEMFCs cells are devices that convert the chemical energy of hydrogen into electricity through electrochemical reaction with oxygen. FIG. 1 presents one representation of an example of a fuel cell 100. The fuel cell 100 includes a membrane- electrode assembly (MEA) 110 comprising a proton exchange membrane 120, positioned between an anode 130 and a cathode 140. A first microporous layer 150 contacts the anode 130. An anode gas diffusion layer 170 contacts the first microporous layer 150 and a first flow channel 190 contacts the anode gas diffusion layer 170. A second microporous layer 160 contacts the cathode 140. A cathode gas diffusion layer 180 contacts the second microporous layer 160 and a second flow channel 200 contacts the cathode gas diffusion layer 180. Not pictured in FIG. 1, an anode bipolar plate may contact the first flow channel 190 and a cathode bipolar plate may contact the second flow channel 200.

It will be understood that the proton exchange membrane (PEM) places the anodic catalyst layer and the cathodic catalyst layer in protic communication with one another. The construct can include an anode gas diffusion layer 170 and the cathode gas diffusion layers 180, respectively, in contact with the anodic catalyst layer and the cathodic catalyst layer, respectively. The anode and cathode gas diffusion layers, 170 and 180, respectively, are configured to allow hydrogen and oxygen gas to diffuse to the anodic and cathodic catalyst layers, respectively, and to allow water product to diffuse away from the cathodic catalyst layer.

The first microporous layer 150 and the second microporous layer 160 are mainly composed of a water-repellent resin and an electrically conductive material. In some embodiments, carbon, or polytetrafluoroethylene (PTFE) are utilized in the first microporous layer 150 and the second microporous layer 160.

The anode gas diffusion layer 170 and the cathode gas diffusion layer 180, contacting the anode 130 and cathode 140 respectively, are made of a material having gas permeability and electrical conductivity and may be made of a carbon porous material such as carbon paper, carbon cloth, glass-like carbon, or the like. Other examples use a porous metallic body. In some embodiments, the gas permeability, or the degree of permeation of the reactive gas through the anode diffusion layer or through the cathode diffusion layer is substantially uniform over the whole surface of the diffusion layer according to this embodiment. In some embodiments, carbon paper or carbon cloth are utilized.

The first flow channel 190 is provided to let fuel gas flow on the surface of the anode diffusion layer. The second flow channel 200 is provided to allow oxidizing gas flow on the surface of the cathode diffusion layer. In some embodiments, the first and second flow channels are formed from carbon resin, stainless steel, titanium, a titanium alloy, or an electrically conductive ceramic material.

The fuel gas is typically hydrogen. The hydrogen gas may be stored in a storage tank. Optionally, hydrogen may be stored as metal hydrides or may be hydrogen obtained by reforming a hydrocarbon fuel.

The oxidizing gas is typically an oxygen-containing gas. In some embodiments, the oxidizing gas is ambient air.

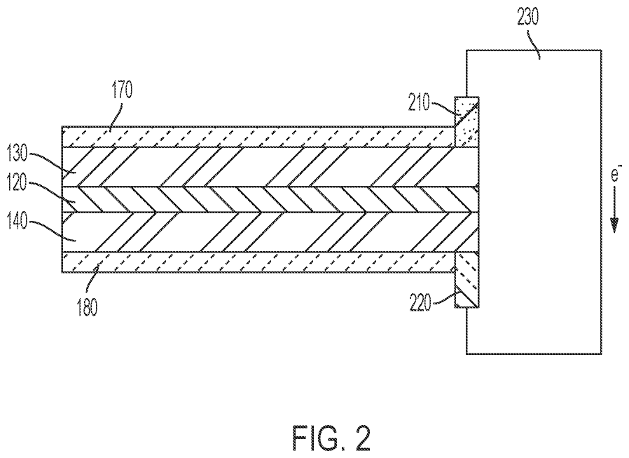

As shown in FIG. 2, the fuel cell comprising a proton exchange membrane 120, anode 130, cathode 140, anode gas diffusion layer 170 and cathode gas diffusion layer 180 can further include anodic current collectors 210 and cathodic current collectors 220, configured to be in electric communication with the anodic and cathodic catalyst layers, respectively, and to connect to be connected to an external circuit 230.

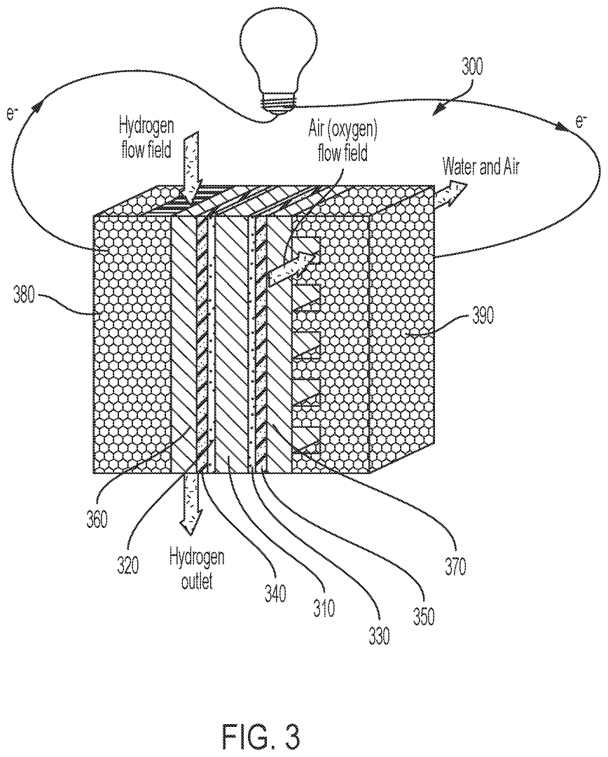

FIG. 3 illustrates an example of a fuel cell 300 having a polymer electrolyte membrane 310, an anodic catalytic layer 320 and a cathodic catalytic layer 330. An anode microporous layer 340 contacts the anodic catalytic layer 320. An anode gas diffusion layer 360 contacts the anode microporous layer 340. A cathode microporous layer 350 contacts the cathodic catalytic layer 330. A cathode gas diffusion layer 370 contacts the cathode microporous layer 350. An anode bipolar plate 380 contacts the anode gas diffusion layer 360 and a cathode bipolar plate 390 contacts the cathode gas diffusion layer 370. Hydrogen and air flow within the cell is illustrated in FIG. 3. Hydrogen (H₂) is fed to the anode side of the fuel cell and an oxygen source (such as ambient air) is fed to the cathode side of the fuel cell. In FIG. 3, water and excess air are depicted as exiting the cathode side of the fuel cell and unreacted hydrogen is shown as exiting the anode side of the fuel cell.

The anode bipolar plate 380 and the cathode bipolar plate 390 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because electrolyte membrane surfaces are strongly acidic, the bipolar plates provide good corrosion resistance. The main purpose a bipolar plate fulfills in a PEMFC stack is to supply fuel (hydrogen) and oxygen to the cell and also to manage heat produced and water flow. It is also used as a backing medium for stacking individual fuel cells.

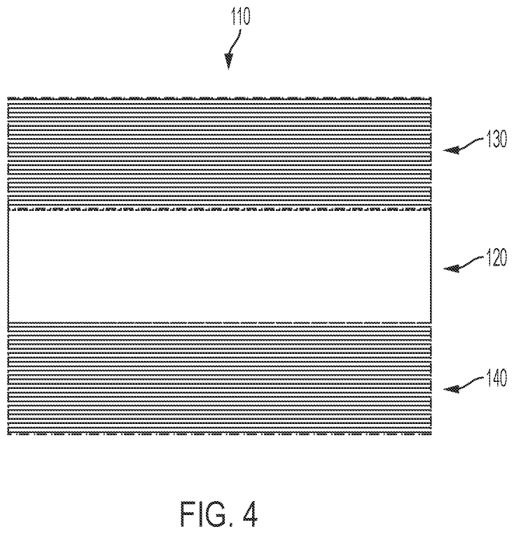

FIG. 4 is another illustration of membrane-electrode assembly (MEA) 110 comprising a proton exchange membrane 120, an anode 130, and a cathode 140.

The proton exchange membrane 120 is configured to support proton transfer (i.e., proton conduction) across the membrane, and to be electrically insulative. The proton exchange membrane 120 can be a pure polymer membrane or a composite membrane, and can be formed of any suitable material, such as a perfluorosulfonic acid polymer, other fluoropolymers, hydrocarbon polymers, or any other suitable material. The MEA 110 further includes an anode 130 comprising an anodic catalyst layer, configured to electrolytically catalyze an anodic hydrogen-splitting reaction:

H₂→2e⁻+2H⁺.

The anodic catalyst layer can be substantially formed of anodic catalyst particles of platinum or a platinum alloy supported on carbon, such as carbon black.

The MEA 110 further includes a cathode 140, configured to catalyze an oxygen reduction reaction:

O₂+4e⁻+4H⁺→2H₂O.

The cathodic catalyst layer can include cathodic catalyst particles of platinum or a platinum alloy supported on carbon, such as carbon black. In some implementations, the cathodic catalyst particles will be a platinum-cobalt alloy. In some such implementations, the weight ratio of platinum to cobalt can be about 3:1 to about 15:1. In certain embodiments the ratio is about 10:1.

In some embodiments, the proton exchange membrane is a perfluorosulfonic acid (PFSA) polymer ion exchange membrane. PFSA polymers are commercially available. Non-limiting examples of PFSA polymers are the lines of products sold under the tradenames Nafion™ (marketed by the Chemours Company) and Aquivion™ (marketed by Solvay). An anode catalyst layer and a cathode catalyst layer are made of a material having gas permeability and electrical conductivity and supporting a catalyst (e.g., platinum or platinum alloy) for accelerating the electrochemical reaction of hydrogen with oxygen and are made of a carbon carrier with the catalyst supported thereon. The anode layer and cathode layers are opposite faces of the proton exchange membrane.

The first catalyst and the second catalyst each are independently a platinum or platinum alloy catalyst. In some embodiments, the platinum or platinum alloy is loaded on a conductive support such as carbon. Suitable carbon conductive supports include, but are not limited to, carbon black, graphite, activated carbon, and carbon nano tubes. Platinum alloys include platinum-cobalt alloys. Examples of such alloys are described in U.S. Pat. No. 7,940,080.

In some implementations, the anodic catalyst layer and/or the cathodic catalyst layer can include a solid ionomer, such as a fluorinated polymer, e.g., perfluorosulfonic acid (PFSA) such NAFION^{(R)} marketed by the Chemours company. Other commercially available examples include FLEMION® (Asahi Glass Company) ACIPLEX® (Asahi Kasei) and FUMION® (FuMA-Tech).

In some implementations, the anodic and/or cathodic catalyst particles can have an average maximum dimension of 2-5 nm. In some implementations, the anodic and/or cathodic catalyst particles will include porous particles which provide increased surface area for catalyst activity.

In order to achieve an improved lifespan of the PEMFCs beyond the typical operational lifetime of 5,000 hours, antioxidants are used to react with the free radicals generated from the catalytic reaction of the PEMFCs. For example, cerium oxide is used as a reservoir of cerium ions that act as an antioxidant. More specifically, Ce³⁺ and Ce⁴⁺ is generally used in the proton exchange membranes, the electrodes, or the gas diffusion layers, to prevent chemical degradation to the membranes and ionomers in the PEMFCs. In particular, it is believed that cerium ions mitigate chemical attacks from free radicals to the membrane and other components in the fuel cell. While not wanting to be bound by any particular theory, cerium(III) ions are believed to be oxidized by hydroxyl radicals (HO·) to form tetravalent cerium(IV) ions and water; the former are subsequently regenerated back to cerium(III) through rapid reduction by hydroperoxyl radicals (HOO·) or hydrogen peroxide (H₂O₂). Yttrium doped cerium oxide, zirconium doped cerium oxide, and manganese oxide may also be employed as an antioxidant.

While use of cerium ions (Ce³⁺ and Ce⁴⁺) in proton exchange membranes can prevent damage to the proton exchange membrane, in the radical quenching reactions, some cerium ions will migrate to other parts of the fuel cell. Some of the cerium ions will leach out of the PEMFC with water. The resulting cerium ions in the fuel cell can poison the catalyst and reduce the ion conductivity of the ionomer and the proton exchange membrane. The most common ionomer and polymer are perfluorosulfonic acid (PFSA). Either of these events will cause a decrease in fuel cell performance and efficiency. In addition, contaminated membranes are subject to reduced mechanical stability which negatively impacts fuel cell life.

In order to maintain a desired cerium ion concentration in a fuel cell for mitigating free radicals for heavy-duty vehicle applications, a larger amount of antioxidant needs to be added to the fuel cell stack, i.e., a plurality of stacked membrane electrode assemblies (MEAs) which make up the PEMFC. Without a release strategy, however, a higher cerium ion concentration will be in fuel cell stack which lowers fuel cell performance and durability. This will cause higher initial material costs (bigger stack) and more fuel (H₂) costs for customers. The instant disclosure, in some aspects, concerns controlled release technology to control the antioxidant concentration, such as cerium ion concentration, in the membrane-electrode assembly (MEA) to allow the operational lifetime needed for heavy-duty vehicle fuel cells, and other vehicle fuel cells. Yttrium doped cerium oxide, zirconium doped cerium oxide, and manganese oxide may also be employed as an antioxidant within the scope of the present disclosure.

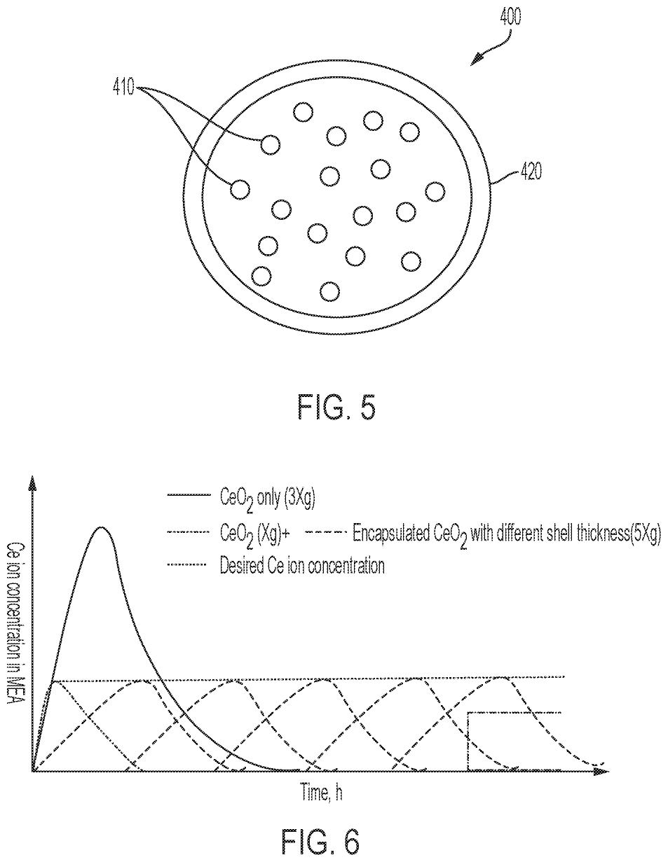

“Controlled release” as used herein refers to delayed and/or slowed release of the antioxidant at predetermined intervals or gradually over a period of time. “Controlled release” also includes, “sustained release”, “extended release”, and/or “delayed release”. In the present disclosure, controlled release of the antioxidant is achieved by providing the antioxidant in a controlled release form selected from microcapsules or microspheres. As illustrated in FIG. 5, microcapsules 400 of the present disclosure, comprise a core material 410 comprising antioxidant microparticles, such as cerium oxide microparticles, and a polymer shell 420 surrounding the core material, wherein the polymer shell has a predetermined thickness to control release of the antioxidant. The core can be purely solid with the microparticles, such as CeO₂, or a mixture of the microparticles and water, such as CeO₂/water. The core material inside the capsule may also be referred to as an internal phase, or fill, or filler, and the shell, may also be referred to as the wall, coating, or matrix. The polymer shell completely surrounds or encapsulates the core material comprising cerium oxide particles so that the core material is isolated from the external environment and the polymer shell thereby controls or delays exposure or release of the cerium oxide particles to the PEM, electrode, and/or gas diffusion layer. FIG. 6 illustrates the controlled release profile of the antioxidant using CeO₂/Ce ions as an example. FIG. 6 also shows that the thickness of the polymer shell can be varied, for example, increased, for subsets of the microcapsules to provide further delay in the release of the antioxidant over time.

In some examples the thickness of the polymer shell is in the range of about 50 nm to about 9 μm. The overall loading of cerium ions can be controlled to a predetermined level so that fuel cell performance will not decrease significantly over time. The microspheres and microcapsules of the present disclosure have a particle size within the range of between 100 nm to 10 μm. The microspheres and microcapsules of the present disclosure should be small enough to fit into catalyst layer (˜10 μm) and the microporous layer (<40 μm). If the particles are too large, e.g., more than 10 μm, they may significantly affect the integrity of the catalyst layer or microporous layer.

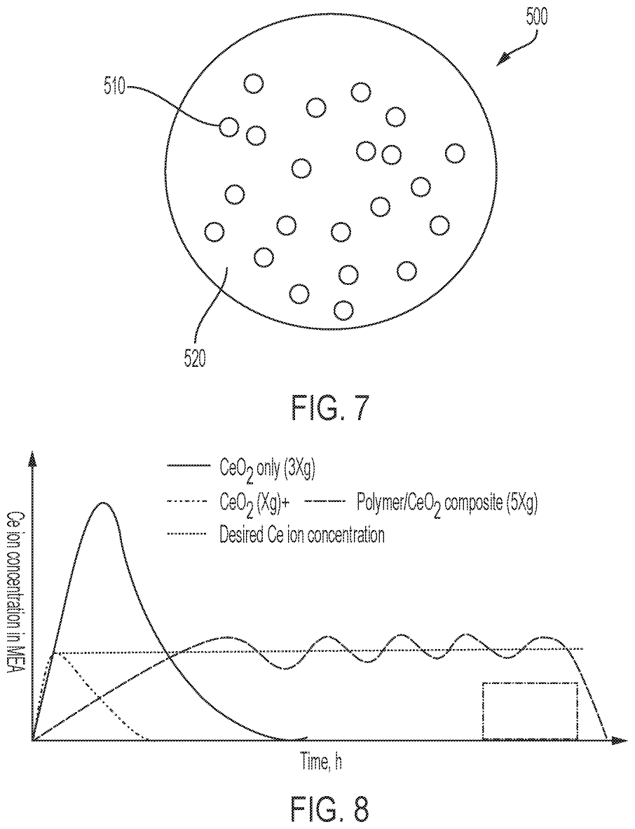

As illustrated in FIG. 7, microspheres 500 of the present disclosure comprise antioxidant microparticles 510, such as cerium oxide microparticles, incorporated or dispersed within a polymer 520, such as a matrix, wherein the polymer 520, is selected to control release of the antioxidant microparticles 510 overtime. FIG. 6 illustrates the controlled release profile of the antioxidant using CeO₂/Ce ion as an example and shows that the release can be customized by optimizing the polymer composition and the antioxidant loading in the microspheres.

Microcapsules of the present disclosure can be formed by any suitable microencapsulation technique. Microencapsulation is generally a process wherein small individual particles form a core material and are surrounded by a shell of a continuous film or polymeric material. The core material is completely coated or surrounded and isolated from the external environment by the shell. Microspheres of the present disclosure can be formed by spray drying which is a microencapsulation technique wherein the particles or core material is suspended or dissolved in a melt or polymer solution and becomes trapped in the dried particle. Other suitable microencapsulation techniques include, but are not limited to, simple or complex coacervation, solvent evaporation, ionic gelation, thermal gelation, sonochemical processes, layer-by-layer adsorption, flash nanoprecipitation, electrospraying, in situ polymerization, interfacial polymerization including, but not limited to suspension polymerization, dispersion polymerization, and emulsion polymerization, and interfacial polycondensation/polyaddition, interfacial crosslinking, ionic polymerization, and sol-gel polymerization.

Microspheres of the present disclosure can also be formed by mixing or incorporating the antioxidant particles within a polymer matrix to form a composite. A “composite”, as used herein, refers to a material made of two or more constituent materials with different physical or chemical properties. In forming the microspheres of the present disclosure, the antioxidant particles are homogeneously dispersed within the matrix. In some examples, the antioxidant particles are dissolved or suspended in the polymer matrix.

Polymers that are able to be slowly degraded by free radicals for release of the radical quenchers can be used for the polymer shell and/or the polymer matrix. Suitable polymers include, but are not limited to, natural polymers, synthetic polymers, and polymers that occur naturally and synthetically. Suitable natural polymers include but are not limited to, gelatin, chitosan, starch, Arabic gum, gums, albumin, cysteine, alginate, silk fibroin, and waxes. Suitable, synthetic polymers include, but are not limited to polycaprolactone, poly(methyl methacrylate, poly(lactic acid), poly(glycolic alcohol), polyolefin, and cellulose and cellulosic derivatives, thermosetting resins, including but not limited to, melamine formaldehyde resin, urea-formaldehyde resin, polyurea- formaldehyde resin, and phenol-formaldehyde resin, polyamides, polyureas, polyurethanes, poly(urea-urethanes), polyurethane/chitosan, polyester, polystyrene, polytetrafluorethylene (PTFE), polyvinylidene fluoride (PVDF), polysulfone (PSU), polyether ketone (PEEK), and derivatives and combinations thereof.

The present disclosure is also directed to a method for suppressing or mitigating cerium ion migration in proton exchange membrane fuel cells (PEMFC) which involves loading a predetermined amount of cerium oxide antioxidant to the membrane-electrode assembly, in a controlled release form selected from microcapsules or microspheres configured to release cerium oxide over time as described herein.

Importantly, by using the controlled release concepts described herein, a longer lifespan of the fuel cell can be achieved without sacrificing fuel cell performance significantly. In some examples, the fuel cell has an operational lifetime of more than 5,000 hours, at least 8,000, at least 15,000 hours, at least 20,000 hours, at least 25,000 hours, or at least 30,000 hours.

The present disclosure can be applicable to various other aspects, such as a vehicle driven by utilizing the electric power of the fuel cell, a power generation system that supplies the electric power of the fuel cell, and other articles comprising the fuel cells. In some examples, the vehicle can be a passenger car or truck. In some examples, the power generation system can be stationary.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1: Synthesis and Characterization

Microcapsules of the present disclosure having cerium oxide (CeO₂) nanoparticles as the core and a urea-formaldehyde polymer shell surrounding the core material were synthesized. The urea-formaldehyde polymer was obtained by the following reaction of urea and formaldehyde: encapsulation of CeO₂ was prepared by an in-situ polymerization method. Urea, ammonium chloride, and resorcinol were added to deionized (DI)-water and stirred for 30 mins at room temperature. CeO₂ nanoparticles as the core material were then added to the solution. The pH of the solution was tuned to 3.5 by adding NaOH solution. Then, formaldehyde solution was added and stirred for 30 mins. The temperature of the beaker was then raised to 55° C. on a hotplate for 4 hours to form the encapsulated CeO₂.

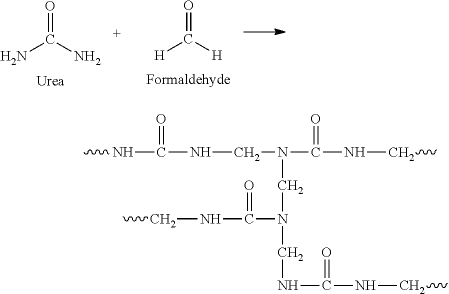

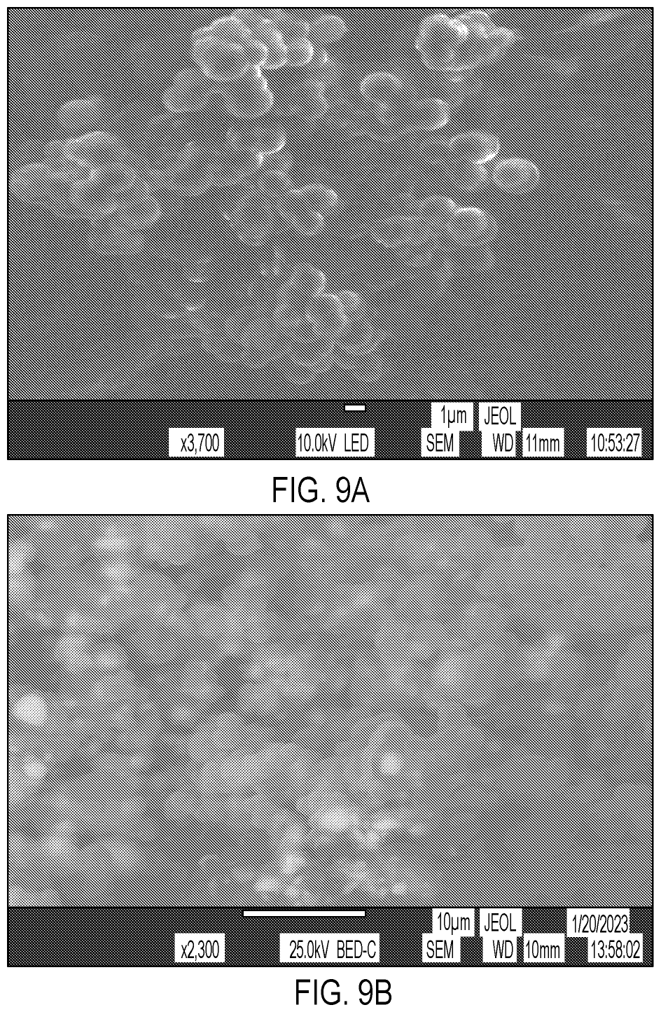

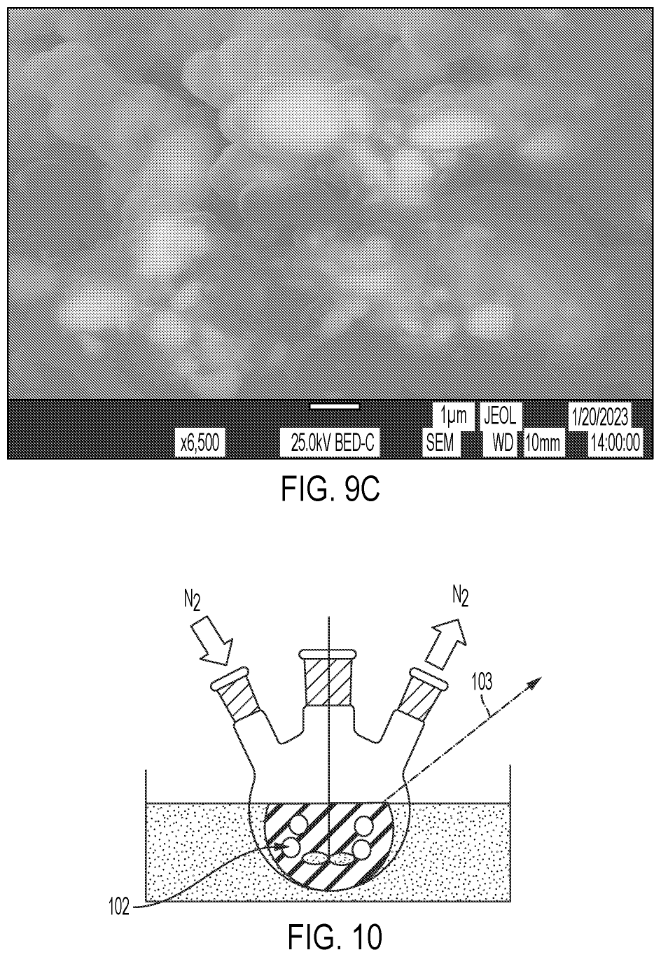

The CeO2 particles had a particle size ˜10 nm-30 nm and the encapsulated CeO2 was between 0.7 μm to 1.7 μm. The urea-formaldehyde polymer shell protects the CeO₂ core. The core-shell particle structure can be seen in the Scanning Electron Microscope (SEM) images of FIG. 9A. Cross-section images of the microcapsules cut by an ion beam are shown in FIGS. 9B and 9C. Black scattered mode in SEM shows the CeO₂ core (bright) and the urea-formaldehyde (UF) polymer shell (dark). In the UF/CeO₂ microcapsules, all of the CeO₂ nanoparticles are covered by the UF shell (FIGS. 9A-9C).

### Example 2: Benzenesulfonic Acid Degradation Test Results

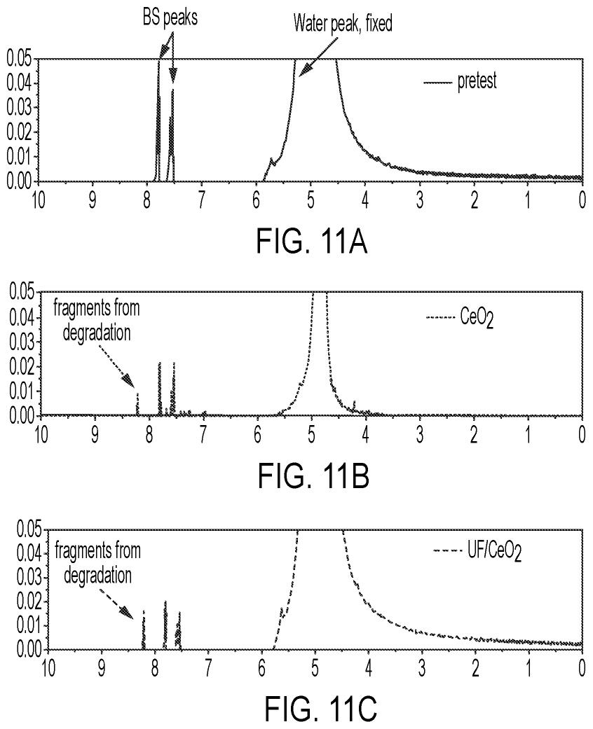

The synthesized UF/CeO₂ microcapsules were submerged in samples containing benzenesulfonic acid and a fixed amount of water as illustrated in FIG. 10. The benzenesulfonic acid and the UF polymer shell of the microcapsules 102 were attacked by the free radicals generated from H₂O₂ causing degradation of the polymer shell. During degradation of the polymer shells, the radical quencher, i.e., cerium oxide (CeO₂ ) was released 103. The remaining benzenesulfonic acid was determined by integration of benzenesulfonic acid peaks and water peaks in NMR spectra as shown in FIGS. 11A, 11B and 11C. Because the water concentrations in the samples were fixed the benzenesulfonic acid concentration could be determined as follows:

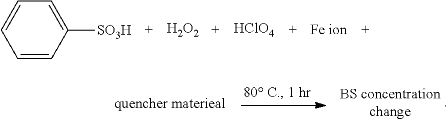

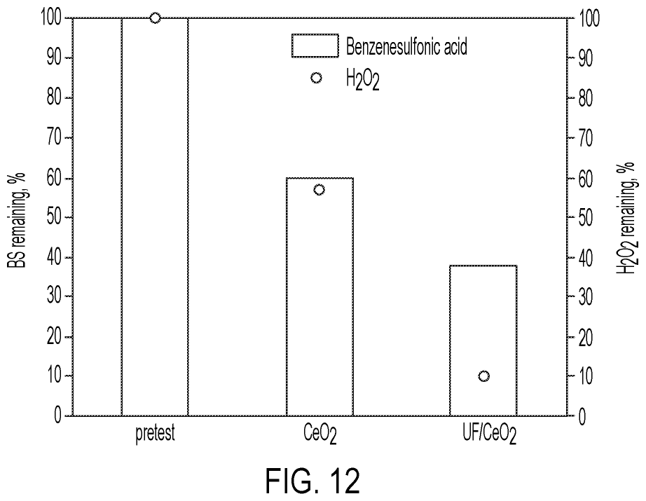

FIG. 12 shows that about 60% of benzenesulfonic acid remains from CeO₂ and about 38% of benzenesulfonic acid remains from UF/CeO₂ microcapsules in accordance with the present disclosure. Due to the absence of CeO₂ directly quenching radicals, the UF/CeO₂ microcapsules cannot slow down benzenesulfonic acid degradation as evidenced by the lower amount of benzenesulfonic acid remaining. Consequently, more H₂O₂ was consumed. Accordingly, the urea-formaldehyde (UF) shell delays the release of CeO₂. It follows that the thickness of the polymer shell can be varied to control the release of the antioxidant over time.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearance of the phrase “in one aspect” (or variations thereof) does not necessarily refer to the same aspect or embodiment. It should also be understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A membrane-electrode assembly comprising:
an anode comprising a first catalyst;
a cathode comprising a second catalyst; and
a proton exchange membrane between the anode and cathode,
wherein at least one of the proton exchange membrane, anode, and cathode comprise an antioxidant which comprises cerium oxide microparticles in a controlled release form selected from microcapsules or microspheres configured to release cerium oxide over time.

2. The membrane-electrode assembly of claim 1, wherein the cerium oxide antioxidant is in the form of microcapsules, said microcapsules comprising:
a core which comprises cerium oxide microparticles, and
a polymer shell surrounding the core, wherein the polymer shell has a predetermined thickness to control the release of the cerium oxide over time.

3. The membrane-electrode assembly of claim 1, wherein the cerium oxide antioxidant is in the form of microspheres, said microspheres comprising:
cerium oxide microparticles dispersed within a polymer matrix,
wherein the polymer is selected to control release of the cerium oxide microparticles over time.

4. The membrane-electrode assembly of claim 2, wherein the polymer shell or matrix is selected from the group consisting of gelatin, chitosan, starch, Arabic gum, gums, albumin, cysteine, alginate, silk fibroin, waxes, polycaprolactone, poly(methyl methacrylate), poly(lactic acid), poly(glycolic alcohol), polyolefin, cellulose, melamine formaldehyde resin, urea-formaldehyde resin, polyurea-formaldehyde resin, phenol-formaldehyde resin, polyamides, polyureas, polyurethanes, poly(urea-urethanes), polyurethane/chitosan, polyester, polystyrene, polytetrafluorethylene (PTFE), polyvinylidene fluoride (PVDF), polysulfone (PSU), polyether ketone (PEEK), and derivatives and combinations thereof.

5. The membrane-electrode assembly of claim 2, wherein the polymer shell has a thickness of about 50 nm to about 9 μm.

6. The membrane-electrode assembly of claim 1, wherein the proton exchange membrane comprises a perfluorosulfonic acid polymer.

7. A polymer electrolyte membrane fuel cell (PEMFC) comprising a plurality of stacked membrane electrode assemblies (MEAs), wherein each MEA of the plurality comprises a MEA according to claim 1, and wherein the fuel cell has an operational lifetime of at least 8,000 hours.

8. A fuel cell comprising:
a membrane-electrode assembly comprising a proton exchange membrane, an anode comprising a first catalyst, and a cathode comprising a second catalyst, the proton exchange membrane positioned between the anode and cathode;
a first microporous layer contacting the anode;
a second microporous layer contacting the cathode;
an anode diffusion layer contacting the first microporous layer;
a cathode diffusion layer contacting the second microporous layer;
a first flow channel contacting the anode diffusion layer; and
a second flow channel connecting the cathode diffusion layer,
wherein at least one of the proton exchange membrane, anode, cathode, first microporous layer and the second microporous layer comprise a cerium oxide antioxidant in a controlled release form selected from microcapsules or microspheres configured to release cerium oxide over time.

9. The fuel cell of claim 8, wherein the at least one of the proton exchange membrane, anode, cathode, first microporous layer and the second microporous layer comprise cerium oxide antioxidant in the form of microcapsules, said microcapsules comprising:
a core which comprises cerium oxide microparticles, and
a polymer shell surrounding the core, wherein the polymer shell has a predetermined thickness to control the release of the cerium oxide over time.

10. The fuel cell of claim 8, wherein the at least one of the proton exchange membrane, anode, cathode, first microporous layer and the second microporous layer comprise cerium oxide antioxidant in the form of microspheres, said microspheres comprising:
cerium oxide microparticles dispersed within a polymer matrix,
wherein the polymer is selected to control release of the cerium oxide microparticles over time.

11. The fuel cell of claim 9, wherein the polymer shell is selected from the group consisting of gelatin, chitosan, starch, Arabic gum, gums, albumin, cysteine, alginate, silk fibroin, waxes, polycaprolactone, poly(methyl methacrylate), poly(lactic acid), poly(glycolic alcohol), polyolefin, cellulose, melamine formaldehyde resin, urea- formaldehyde resin, polyurea-formaldehyde resin, phenol-formaldehyde resin, polyamides, polyureas, polyurethanes, poly(urea-urethanes), polyurethane/chitosan, polyester, polystyrene, polytetrafluorethylene (PTFE), polyvinylidene fluoride (PVDF), polysulfone (PSU), polyether ketone (PEEK), and derivatives and combinations thereof.

12. The fuel cell of claim 9, wherein the polymer shell has a thickness of about 50 nm to about 9 μm.

13. The fuel cell of claim 8, wherein the proton exchange membrane comprises a perfluorosulfonic acid polymer.

14. A vehicle comprising the fuel cell of claim 8.

15. A method for suppressing cerium ion migration in proton exchange membrane fuel cells (PEMFC) wherein said PEMFC comprises a membrane-electrode assembly which comprises a proton exchange membrane, an anode comprising a first catalyst, and a cathode comprising a second catalyst, the proton exchange membrane comprising a perfluorosulfonic acid polymer and positioned between the anode and cathode;
a first microporous layer contacting the anode;
a second microporous layer contacting the cathode;
an anode diffusion layer contacting the first microporous layer;
a cathode diffusion layer contacting the second microporous layer;
a first flow channel contacting the anode diffusion layer; and
a second flow channel connecting the cathode diffusion layer;
said method comprising:
loading a predetermined amount of cerium oxide antioxidant to the membrane-electrode assembly, in a controlled release form selected from microcapsules or microspheres configured to release cerium oxide over time.

16. The method of claim 15, wherein the cerium oxide antioxidant is in the form of microcapsules, said microcapsules comprising:
a core which comprises cerium oxide microparticles, and
a polymer shell surrounding the core, wherein the polymer shell has a predetermined thickness to control the release of the cerium oxide over time.

17. The method of claim 15, wherein the cerium oxide antioxidant is in the form of microspheres, said microspheres comprising:
cerium oxide microparticles dispersed within a polymer matrix,
wherein the polymer is selected to control release of the cerium oxide microparticles over time.

18. The method of claim 16, wherein the polymer shell is selected from the group consisting of gelatin, chitosan, starch, Arabic gum, gums, albumin, cysteine, alginate, silk fibroin, waxes, polycaprolactone, poly(methyl methacrylate), poly(lactic acid), poly(glycolic alcohol), polyolefin, cellulose, melamine formaldehyde resin, urea- formaldehyde resin, polyurea-formaldehyde resin, phenol-formaldehyde resin, polyamides, polyureas, polyurethanes, poly(urea-urethanes), polyurethane/chitosan, polyester, polystyrene, polytetrafluorethylene (PTFE), polyvinylidene fluoride (PVDF), polysulfone (PSU), polyether ketone (PEEK), and derivatives and combinations thereof.

19. The method of claim 16, wherein the polymer shell has a thickness of about 50 nm to about 9 μm.

20. The method of claim 15, wherein the proton exchange membrane comprises a perfluorosulfonic acid polymer.
